(19) United States
(12) Patent Application Publication
(10) Pub. No.: US 2024/0258583 A1
(43) Pub. Date: Aug. 1, 2024

(54) LITHIUM METAL SECONDARY BATTERY, SECONDARY BATTERY MODULE, AND SEPARATOR FOR LITHIUM METAL SECONDARY BATTERY

(71) Applicant: HONDA MOTOR CO., LTD., Tokyo (JP)

(72) Inventor: Kazuki SAIMEN, Saitama (JP)

(21) Appl. No.: 18/426,372

(22) Filed: Jan. 30, 2024

(30) Foreign Application Priority Data
Feb. 1, 2023 (JP) 2023-013907

(51) Int. Cl. H01M 10/42; H01M 4/02; H01M 4/134; H01M 4/38; H01M 10/0525; H01M 50/449; H01M 50/489

(52) U.S. Cl. CPC H01M 10/4235; H01M 4/134; H01M 4/382; H01M 10/0525; H01M 50/449; H01M 50/489; H01M 2004/027

(57) ABSTRACT

The lithium metal secondary battery of the present invention includes an electrode stack formed by stacking a positive electrode and a negative electrode having a negative electrode current collector with a separator interposed therebetween, and an electrolyte solution, in which lithium is deposited on the negative electrode current collector during charging and dissolved during discharging; the separator includes a porous membrane and a porous conductive coat layer stacked on at least part of the surface of the porous membrane on the side of the negative electrode, in which the electrical conductivity of the porous conductive coat layer is within the range of 1.0×10¹ to 1.0×10⁵ S/cm, and the surface resistivity of the porous conductive coat layer is 200 Ω/cm² or less.

This application is based on and claims the benefit of priority from Japanese Patent Application No. 2023-013907, filed on 1 Feb. 2023, the content of which is incorporated herein by reference.

### BACKGROUND OF THE INVENTION

### Field of the Invention

The present invention relates to lithium metal secondary batteries, secondary battery modules, and separators for lithium metal secondary batteries.

### Related Art

In recent years, research and development on secondary batteries contributing to the efficiency of energy have been conducted to ensure that more people can secure access to affordable, reliable, sustainable, and advanced energy.

In lithium-ion secondary batteries, in order to prevent metal deposition on the negative electrode, it is known to interpose a conductive porous body between the positive and negative electrodes and to place separators between the positive electrode and the conductive porous body as well as between the negative electrode and the conductive porous body (Japanese Unexamined Patent Application, Publication No. 2015-141864).
Patent Document 1: Japanese Unexamined Patent Application, Publication No. 2015-141864

### SUMMARY OF THE INVENTION

An issues to be addressed in the technical field of secondary batteries is the increase in capacity. In order to increase the capacity of secondary batteries, the practical application of lithium metal secondary batteries that includes lithium metal as the negative electrode active material is desired. However, in lithium metal secondary batteries, through repeated charge and discharge cycles, a solid electrolyte interphase (SEI) layer accumulates at the interface between the negative electrode current collector and lithium, making the formation of lithium dendrites more likely during charging. The formation of lithium dendrites can lead to the risk of them penetrating the separator and causing a short circuit between the positive and negative electrodes. Furthermore, the formation of lithium dendrites can cause a reduction in the density of the lithium layer deposited on the negative electrode current collector (active material layer), leading to excessively large expansion of the lithium secondary battery during charging.

The present invention has been made in view of the above circumstances and aims to provide a lithium metal secondary battery and a secondary battery module that are less likely to short circuit and less likely to reduce the density of the negative electrode active material layer in the charged state, even after repeated charge and discharge cycles. Furthermore, the present invention contributes to energy efficiency.

The inventor of the present invention has found that, in order to solve the above-mentioned problems, it is effective to use a stack, in which a porous conductive coat layer having an electrical conductivity and surface resistivity within a specified range is stacked on the surface of a porous membrane, as a separator, and to arrange the porous conductive coat layer on the negative electrode side. Therefore, the present invention provides the following:

(1) A lithium metal secondary battery including an electrode stack formed by stacking a positive electrode and a negative electrode having a negative electrode current collector with a separator interposed therebetween, and an electrolyte solution, in which lithium is deposited on the negative electrode current collector during charging and dissolved during discharging, in which the separator includes a porous membrane and a porous conductive coat layer stacked on at least part of the surface of the porous membrane on the side of the negative electrode, in which the electrical conductivity of the porous conductive coat layer is within a range of 1.0×10¹ to 1.0×10⁵ S/cm, and in which the surface resistivity of the porous conductive coat layer is 200 Ω/cm² or less.

According to the lithium metal secondary battery of (1), since the electrical conductivity of the porous conductive coat layer arranged on the negative electrode side of the separator is within the specified range, lithium can be uniformly deposited between the separator and the negative electrode current collector during charging. Moreover, since the surface resistivity of the porous conductive coat layer is 200 Ω/cm² or less, it is easier for electrons to be supplied to the porous conductive coat layer side during charging, thus promoting nucleation of lithium on the porous conductive coat layer. In other words, many sites for lithium deposition are formed on the porous conductive coat layer, resulting in the effect of reducing current density during charging. The reduction in current density during charging leads to a decrease in overpotential, thus suppressing the decomposition of the electrolyte solution. Therefore, according to the lithium metal secondary battery of (1), short circuits are less likely to occur even after repeated charge and discharge cycles. Also, the negative electrode active material in the charged state becomes compact and denser.

(2) The lithium metal secondary battery as described in (1), in which the porous conductive coat layer has a region that contacts the lithium deposited on the negative electrode current collector.

According to the lithium metal secondary battery of (2), since the porous conductive coat layer comes into contact with the lithium deposited on the negative electrode current collector, the potential of the porous conductive coat layer and the potential of the negative electrode current collector become the same, which allows for more uniform deposition of lithium between the separator and the negative electrode current collector.

(3) The lithium metal secondary battery as described in (1) or (2), in which the electrical conductivity of the negative electrode current collector is higher than the electrical conductivity of the porous conductive coat layer.

According to the lithium metal secondary battery of (3), since the electrical conductivity of the negative electrode current collector is higher than the electrical conductivity of the porous conductive coat layer, lithium is more likely to be deposited on the side of the negative electrode current collector during charging, making it less likely for lithium to be deposited at the interface between the porous conductive coat layer and the separator and thus preventing clogging of the separator.

(4) The lithium metal secondary battery as described in any one of (1) to (3), in which the peel strength of the porous conductive coat layer against the porous membrane is 0.5 N/m or more.

According to the lithium metal secondary battery of (4), since the peel strength of the porous conductive coat layer is high, the porous conductive coat layer can stably function over a long period. Moreover, since no physical space occurs between the porous membrane and the porous conductive coat layer, lithium can be more easily deposited on the negative electrode current collector side during charging. Therefore, the lithium metal secondary battery of (4) will have a longer charge-discharge cycle life.

(5) The lithium metal secondary battery as described in any one of (1) to (4), in which the thickness of the porous conductive coat layer is within the range of 0.01 to 5 μm.

According to the lithium metal secondary battery of (5), since the thickness of the porous conductive coat layer is within the specified range, the aforementioned effects of the porous conductive coat layer can be achieved without excessively reducing the capacity of the lithium metal secondary battery.

(6) A secondary battery module including the plurality of lithium metal secondary batteries as described in any one of (1) to (5), in which the plurality of lithium metal secondary batteries are each restrained with the restraining force within the range of 0.1 to 2.0 MPa along the stacking direction of the electrode stack.

According to the secondary battery module of (6), since each of the plurality of lithium metal secondary batteries is restrained along the stacking direction of the electrode stack with the specified restraining force, the electrical resistance between the electrodes stabilizes even if the thickness of the negative electrode changes due to charging and discharging. Therefore, according to the secondary battery module of (6), the charge-discharge characteristics become stable.

(7) A separator for a lithium metal secondary battery, in which the separator includes a porous membrane and a porous conductive coat layer stacked on one surface of the porous membrane, the electrical conductivity of the porous conductive coat layer is within the range of 1.0×10¹ to 1.0×10⁵ S/cm, and the surface resistivity of the porous conductive coat layer is 200 Ω/cm² or less.

According to the separator for the lithium metal secondary battery of (7), by arranging the porous conductive coat layer on the negative electrode side, it is possible to obtain a lithium metal secondary battery and a secondary battery module that are less likely to reduce the density of the negative electrode active material layer during charging.

According to the present invention, it is possible to provide a lithium metal secondary battery and a secondary battery module that are less prone to short-circuiting and less likely to experience a reduction in the density of the negative electrode active material layer in a charged state, even after repeated charge and discharge cycles. Furthermore, the present invention can provide a separator for lithium metal secondary batteries, which can be advantageously used to realize lithium metal secondary batteries and secondary battery modules which are less likely to short-circuit after repeated charge and discharge cycles and less likely to have a reduction in the density of the negative electrode active material layer during charging.

### BRIEF DESCRIPTION OF THE DRAWINGS

FIG. 1 is a cross-sectional view illustrating a lithium metal secondary battery in a discharged state according to an embodiment of the present invention;

FIG. 2 is an enlarged cross-sectional view of the separator of the lithium metal secondary battery illustrated in FIG. 1;

FIG. 3 is a cross-sectional view illustrating a lithium metal secondary battery in a charged state according to an embodiment of the present invention;

FIG. 4 is a cross-sectional SEM photograph of the negative electrode active material layer of a lithium metal secondary battery in a charged state obtained in Example 3 after 50 charge-discharge cycles;

FIG. 5 is a cross-sectional SEM photograph of the negative electrode active material layer of a lithium metal secondary battery in a charged state obtained in Comparative Example 1 after 50 charge-discharge cycles; and

FIG. 6 is a cross-sectional SEM photograph of the negative electrode active material layer of a lithium metal secondary battery in a charged state obtained in Comparative Example 5 after 50 charge-discharge cycles.

### DETAILED DESCRIPTION OF THE INVENTION

Hereinafter, embodiments of the present invention will be described with reference to the drawings. However, the embodiments illustrated below are illustrative of the present invention and are not intended to limit the present invention.

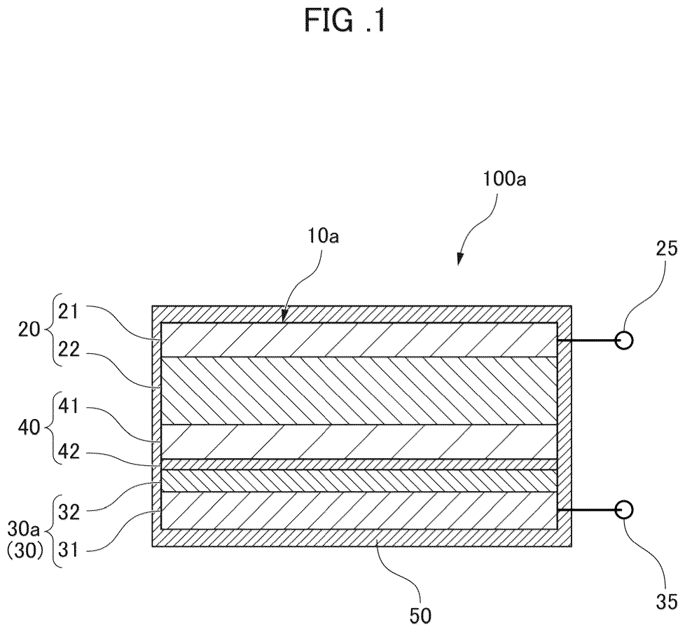

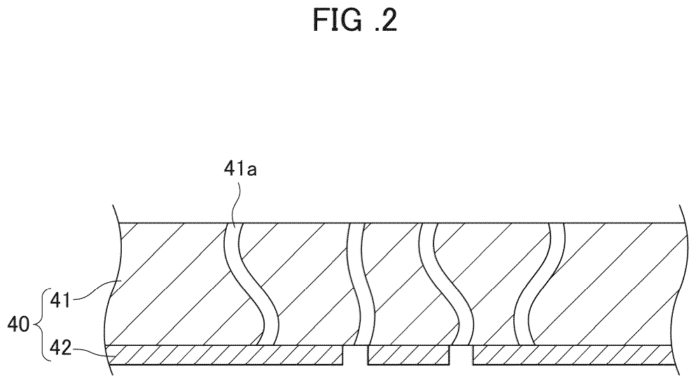

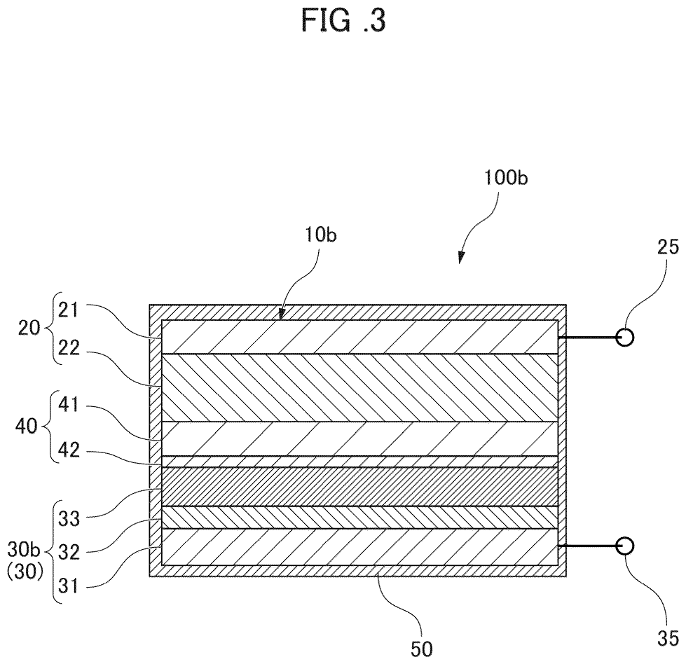

FIG. 1 is a cross-sectional view illustrating a lithium metal secondary battery in a discharged state according to an embodiment of the present invention, and FIG. 2 is an enlarged cross-sectional view of the separator of the lithium metal secondary battery illustrated in FIG. 1. FIG. 3 is a cross-sectional view illustrating a lithium metal secondary battery in a charged state according to an embodiment of the present invention. As illustrated in FIGS. 1 to 3, the lithium metal secondary battery 100a in the discharged state and the lithium metal secondary battery 100b in the charged state according to the present embodiment include an electrode stack 10a, 10b, and an electrolyte solution (not illustrated). The electrode stack 10a, 10b is a stack in which a positive electrode 20 and a negative electrode 30 are stacked with a separator 40 interposed between them. The electrode stack 10a, 10b and the electrolyte solution (not illustrated) are housed within an exterior body 50.

In the electrode stack 10a of the lithium metal secondary battery 100a in the discharged state, the negative electrode 30a includes a negative electrode current collector 31 and a lithium foil 32 arranged on the surface of the negative electrode current collector on the positive electrode side, as illustrated in FIG. 1. The discharged state includes a state immediately after the manufacture of the lithium metal secondary battery 100a. During charging, lithium released from the positive electrode 20 is deposited on the negative electrode current collector 31 through the lithium foil 32, and as illustrated in FIG. 3, a negative electrode active material layer 33 is formed. Therefore, the negative electrode 30b of the lithium metal secondary battery 100b in the charged state becomes thicker in thickness and expands in volume, as compared to the negative electrode 30a of the lithium metal secondary battery 100a in the discharged state. During discharge, the lithium metal in the negative electrode active material layer 33 dissolves, and as illustrated in FIG. 1, the negative electrode active material layer 33 disappears. Therefore, the electrode stack 10a of the lithium metal secondary battery 100a in the discharged state contracts in volume and becomes thinner in thickness of the negative electrode 30, as compared to the electrode stack 10b of the lithium metal secondary battery 100b in the charged state. It is preferable for the negative electrode active material layer 33 to be a single-phase of lithium metal. However, the negative electrode active material layer 33 may also include a lithium-electrolyte reaction component (SEI: Solid Electrolyte Interphase) which is a reaction product of lithium and the electrolyte solution.

The positive electrode 20 includes a positive electrode current collector 21 and a positive electrode active material layer 22. The positive electrode current collector 21 is led out externally by a positive electrode lead terminal 25. Aluminum (Al), for example, can be used as the material for the positive electrode current collector 21. The material for the positive electrode lead terminal 25 can be the same as that of the positive electrode current collector 21.

The positive electrode active material layer 22 contains a positive electrode active material. Examples of the positive electrode active material may include lithium cobaltate (LiCoO₂), lithium nickelate (LiNiO₂), LiNiₚMn_{q}COᵣO₂ (where p+q+r=1), LiNiₚAl_{q}COᵣO₂ (where p+q+r=1), lithium manganate (LiMn₂O₄), hetero element-substituted Li—Mn spinel represented by Li₁₊ₓMn_{2-x-y}M_{y}O₄ (where x+y=2, and M is at least one selected from Al, Mg, Co, Fe, Ni, and Zn), lithium titanate (oxides containing lithium and titanium), and metallic lithium phosphate (LIMPO₄, where M is at least one selected from Fe, Mn, Co, and Ni). The positive electrode active material layer 22 may also contain various additives used as materials for the positive electrode active material layer, such as binders and conductive aids.

The negative electrode current collector 31 of the negative electrode 30 is led out externally by a negative electrode lead terminal 35. Copper (Cu), for example, can be used as the material for the negative electrode current collector 31. The material for the negative electrode lead terminal 35 can be the same as that of the negative electrode current collector 31.

The lithium foil 32 acts to suppress the formation of lithium dendrites during charging and to densify the deposited lithium.

The separator 40 includes a porous membrane 41 and a porous conductive coat layer 42 stacked on the surface of the porous membrane 41 on the side of the negative electrode 30. The porous conductive coat layer 42 does not need to be stacked over the entire surface of the porous membrane 41. As illustrated in FIG. 2, the porous conductive coat layer 42 may be stacked so as to cover part of the pores 41a of the porous membrane 41.

The porous membrane 41 is not particularly limited and can be any known type used as a separator for lithium metal secondary batteries, such as porous body sheets, nonwoven fabric sheets, etc. Examples of materials for the porous body sheet may include polyolefins such as polyethylene and polypropylene, aramid, polyimide, fluororesin, etc. Examples of materials for the nonwoven fabric sheet may include glass fiber, cellulose fiber, etc. The thickness of the porous membrane 41 is not particularly limited but is preferably 10 μm or more from the perspective of blocking lithium metal dendrites, and preferably 15 μm or less from the perspective of reducing resistance within the battery. More preferably, the thickness of the porous membrane 41 is within the range of 10 to 12 μm. The air permeability of the porous membrane 41 is not particularly limited but is preferably 200 sec/100 mL or less, and more preferably 150 sec/100 mL or less, from the perspective of reducing resistance within the battery. The porosity of the porous membrane 41 is not particularly limited but is preferably within the range of 40% to 60% from the perspective of the uniform diffusion of lithium within the separator 40 and the strength of the separator 40.

The electrical conductivity of the porous conductive coat layer 42 is within the range of 1.0×10¹ to 1.0×10⁵ S/cm. Since the electrical conductivity of the porous conductive coat layer 42 is 1.0×10¹ S/003 cm or more, lithium can be deposited on the surface of the porous conductive coat layer 42, and the growth of lithium dendrites toward the positive electrode 20 side causing a short circuit can be suppressed. Additionally, by having an electrical conductivity of 1.0×10⁵ S/cm or less, lithium can be uniformly deposited on the surface of the porous conductive coat layer 42.

The porous conductive coat layer 42 is in contact with the negative electrode current collector 31 through the lithium foil 32 in a discharged state, and in contact with the negative electrode active material layer 33 in a charged state. This ensures that the potential of the porous conductive coat layer 42 is the same as that of the negative electrode current collector 31, allowing for more uniform deposition of lithium between the separator 40 and the negative electrode current collector 31.

The electrical conductivity of the porous conductive coat layer 42 is lower than the electrical conductivity of the negative electrode current collector 31; that is, the electrical conductivity of the negative electrode current collector 31 may be higher than the electrical conductivity of the porous conductive coat layer 42. By having a higher electrical conductivity for the negative electrode current collector 31 than the electrical conductivity of the porous conductive coat layer 42, the concentration of lithium deposition on the side of the porous membrane 41 of the porous conductive coat layer 42 can be prevented, and damage due to shape changes in the porous conductive coat layer 42 caused by concentrated lithium deposition can be suppressed. The electrical conductivity of the porous conductive coat layer 42 may be, for example, within the range of 1/10 to 1/100,000 of the electrical conductivity of the negative electrode current collector 31.

The peel strength of the porous conductive coat layer 42 against the porous membrane 41 is not particularly limited but is preferably 0.5 N/m or more, more preferably 10 N/m or more, and even more preferably 30 N/m or more. When the peel strength of the porous conductive coat layer 42 is as high as the above values, the porous conductive coat layer 42 can stably function over a long period, resulting in a longer charge-discharge cycle life.

The surface resistivity of the porous conductive coat layer 42 may be 200 Ω/cm² or less.

The thickness of the porous conductive coat layer 42 may be within the range of 0.01 to 5 μm. When the thickness of the porous conductive coat layer 42 is 0.01 μm or more, the effects of the porous conductive coat layer 42 can be achieved. When the thickness of the porous conductive coat layer 42 is 5 μm or less, the reduction in energy density caused by the porous conductive coat layer 42 can be minimized.

Materials for the porous conductive coat layer 42 may include conductive materials such as metals, carbon nanotubes (CNT), etc. Examples of the metals may include Cu, Zn, Ti, and Sn. These conductive materials may be used alone or in combination.

There are no particular restrictions on the coating method to form the porous conductive coat layer 42 on the porous membrane 41; for example, sputtering methods and application methods can be used. The sputtering methods can include DC sputtering and RF sputtering. The application method involves applying a coating liquid, in which the materials for the porous conductive coat layer 42 are dispersed, onto the surface of the porous membrane 41, and then drying it.

The electrolyte solution contains an organic solvent and an electrolyte. Examples of organic solvents may include cyclic carbonates, chain carbonates, cyclic ethers, chain ethers, hydrofluoroethers, aromatic ethers, sulfones, cyclic esters, chain carboxylic acid esters, and nitriles. Examples of cyclic carbonates may include ethylene carbonate, propylene carbonate, vinylene carbonate, fluoroethylene carbonate, etc. Examples of chain carbonates may include dimethyl carbonate, diethyl carbonate, ethyl methyl carbonate, etc. Examples of cyclic ethers may include tetrahydrofuran, 2-methyltetrahydrofuran, tetrahydropyran, 1,3-dioxolane, 4-methyl-1,3-dioxolane, etc. Examples of chain ethers may include 1,2-dimethoxyethane, 1,2-diethoxyethane, ethoxymethoxyethane, diethyl ether, etc. Examples of hydrofluoroethers may include 1,1,2,2-tetrafluoroethyl-2,2,2-trifluoroethyl ether, 1,1,2,2-tetrafluoroethyl-2,2,3,3-tetrafluoropropyl ether, bis(2,2,2-trifluoroethyl) ether, 1,2-bis(1,1,2,2-tetrafluoroethoxy) ethane, etc. An example of aromatic ethers may be anisole. Examples of sulfones may include sulfolane, methyl sulfolane, etc. Examples of cyclic esters may include γ-butyrolactone, etc. Examples of chain carboxylic acid esters may include acetate esters, butyrate esters, propionate esters, etc. Examples of nitriles may include acetonitrile, propionitrile, etc. The organic solvent may be used alone or in combination with two or more types.

The electrolyte, serving as a source of lithium ions which are charge transfer media, includes lithium salts. Examples of lithium salts may include LiPF₆, LiBF₄, LiC₁O₄, LiAsF₆, LiCF₃SO₃, LiC(CF₃SO₂)₃, LIN (CF₃SO₂)₂ (LiTFSI), LIN (FSO₂)₂ (LiFSI), LiBC₄O₈, etc. The lithium salt can be used alone or in combination with two or more types. The concentration of the electrolyte is, for example, within the range of 1.5 to 4.0 mol/L.

The exterior body 50 is designed to be expandable and contractible in accordance with the volume expansion and contraction of the electrode stack 10a, 10b due to charge and discharge. A laminated film can be used as a material for the exterior body 50. The laminated film can be a three-layered laminated film structured in the order of an inner resin layer, a metal layer, and an outer resin layer from the inside. The inner resin layer may be, for example, a polyamide layer, the metal layer may be, for example, an aluminum layer, and the outer resin layer may be, for example, a polypropylene layer.

In the lithium metal secondary batteries 100a, 100b of the present embodiment, since the porous conductive coat layer 42 with the electrical conductivity within the range specified above is arranged on the negative electrode side of the separator 40, lithium can be uniformly deposited between the separator 40 and the negative electrode current collector 31 during charging. Therefore, according to the lithium metal secondary batteries 100a, 100b, short circuits are less likely to occur even after repeated charge and discharge cycles. Furthermore, the negative electrode active material layer 33 of the negative electrode 30b becomes compact and denser in the charged state.

According to the separator 40 of the present embodiment, by arranging the porous conductive coat layer 42 on the side of the negative electrode 30, it is possible to obtain lithium metal secondary batteries 100a, 100b with a compact and dense negative electrode active material layer 33 of the negative electrode 30b in the charged state.

Furthermore, using the plurality of lithium metal secondary batteries 100a, 100b of the present embodiment as a secondary battery module allows for obtaining a battery module that is less likely to short-circuit even after repeated charge and discharge cycles, in which the negative electrode active material layer is compact and dense in the charged state. Moreover, in the secondary battery module, the plurality of lithium metal secondary batteries 100a, 100b may be restrained with a restraining force within the range of 0.1 to 2.0 MPa along the stacking direction of the electrode stacks 10a, 10b. By restraining the lithium metal secondary batteries 100a, 100b with this restraining force, the electrical resistance between the positive electrode 20 and the negative electrode 30 remains stable even when the thickness of the negative electrode 30 changes due to charge and discharge. Hence, the charge-discharge characteristics of the secondary battery module become stable.

The preferred embodiments of the present invention have been described above. However, the present invention is not limited to these embodiments and can be modified as appropriate. For example, in the present embodiment, although the porous conductive coat layer 42 of the separator 40 is stacked over the entire surface of the porous membrane 41 on the side of the negative electrode 30, the porous conductive coat layer 42 may be partially stacked. The porous conductive coat layer 42 is not particularly limited but is preferably formed over the entire surface of the porous membrane 41 facing the negative electrode 30.

Moreover, in the present embodiment, the entire surface of the porous conductive coat layer 42 of the separator 40 is in contact with the negative electrode current collector 31 through the lithium foil 32 in a discharged state, and is in contact with the negative electrode active material layer 33 in a charged state; however, part of the surface area of the porous conductive coat layer 42 may be in contact with the negative electrode current collector 31 or the negative electrode active material layer 33. The porous conductive coat layer 42 is not particularly limited but is preferably in contact with the negative electrode current collector 31 or the negative electrode active material layer 33 over the entire surface area of the negative electrode 30.

### EXAMPLES

### Example 1

### (Preparation of Separator)

A porous membrane (thickness: 20 μm, porosity: 58%, air permeability: 92 sec/100 mL) was prepared. On one surface of the porous membrane, a copper conductive porous layer with a thickness of 0.08 μm was formed using RF sputtering. The porous membrane with the copper conductive porous layer formed thereon was punched out to a size of 40 mm×50 mm to form a separator.

### (Preparation of Positive Electrode)

Acetylene black (AB) as an electron-conductive material, polyvinylidene fluoride (PVDF) as a binder, and polyvinylpyrrolidone (PVP) as a dispersing agent were preliminarily mixed in N-methyl-2-pyrrolidone (NMP) as a dispersion solvent, and wet-mixed using a planetary centrifugal mixer to obtain a pre-mixed slurry. Subsequently, the pre-mixed slurry was mixed with Li₁Ni_{0.8}Co_{0.1}Mn_{0.1}O₂ (NCM811) as a positive electrode active material, and a pre-doping material, and dispersed using a planetary mixer to obtain a positive electrode paste. NCM811 has a median diameter of 12 μm. The obtained positive electrode paste was then coated onto an aluminum positive electrode current collector without a primer layer, dried, applied with pressure using a roll press, and then dried at 120° C. in a vacuum to form a positive electrode plate with a positive electrode composite layer. The obtained positive electrode plate was punched out to a size of 30 mm×40 mm to form a positive electrode.

### (Preparation of Negative Electrode)

A clad material was prepared by bonding a copper foil (thickness: 10 μm, electrical conductivity: 6.5×106 S/cm) with a lithium foil (thickness: 20 μm). This clad material was punched out to a size of 34 mm×44 mm to form the negative electrode.

### (Electrolyte Solution)

An electrolyte solution was prepared by dissolving LiFSI at a concentration of 4 mol/L in 1,2-dimethoxyethane (DME).

### (Preparation of Lithium Metal Secondary Battery)

A stack was prepared by overlapping the copper conductive porous layer of the separator on the lithium foil side of the negative electrode, and the positive electrode composite layer of the positive electrode on the opposite side of the copper conductive porous layer of the separator, such that the negative electrode, separator, and positive electrode were stacked in this order. Subsequently, tabs were attached to the positive electrode current collector and the copper foil of the negative electrode of the obtained stack. The tabbed stack was then placed in a pouch made of laminated film, after which the electrolyte solution was added, and the pouch was sealed to prepare a lithium metal secondary battery.

### Example 2

In preparation of a separator, except for forming a zinc conductive porous layer with a thickness of 0.06 μm by RF sputtering instead of the copper conductive porous layer, a lithium metal secondary battery was prepared in the same manner as in Example 1.

### Example 3

In preparation of a separator, except for forming a carbon nanotube conductive porous layer with a thickness of 2.1 μm by the application method instead of the copper conductive porous layer, a lithium metal secondary battery was prepared in the same manner as in Example 1. The formation of the carbon nanotube conductive porous layer was performed as follows:

Initially, carbon nanotubes were added to N-methyl-N-pyrrolidinone (NMP) as the solvent to achieve a solid concentration of 4% by mass, and PVDF (#9300, manufactured by Kureha Corporation) was added as a binder in the amount of 5 parts by mass relative to 95 parts by mass of carbon nanotubes. Then, a dispersion treatment was carried out for 10 minutes at 1000 rpm using a planetary centrifugal mixer to prepare a coating liquid. The obtained coating liquid was applied to the surface of the porous membrane using a doctor blade and dried.

### Example 4

In preparation of a separator, except for forming a titanium conductive porous layer with a thickness of 0.06 μm by RF sputtering instead of the copper conductive porous layer, a lithium metal secondary battery was prepared in the same manner as in Example 1.

### Comparative Example 1

In preparation of a separator, except for forming no copper conductive porous layer, a lithium metal secondary battery was prepared in the same manner as in Example 1.

### Comparative Example 2

In preparation of a separator, except for forming a graphite conductive porous layer with a thickness of 0.08 μm by RF sputtering instead of the copper conductive porous layer, a lithium metal secondary battery was prepared in the same manner as in Example 1.

### Comparative Example 3

In preparation of a separator, except for forming an acetylene black conductive porous layer with a thickness of 11 μm by the application method using acetylene black (AB) instead of carbon nanotubes, a lithium metal secondary battery was prepared in the same manner as in Example 3.

### Comparative Example 4

In preparation of a separator, except for forming a vapor-grown carbon fiber conductive porous layer with a thickness of 9 μm by the application method by using vapor-grown carbon fibers (VGCF-H) instead of carbon nanotubes, a lithium metal secondary battery was prepared in the same manner as in Example 3.

### Comparative Example 5

In preparation of a separator, except that the thickness of the carbon nanotube conductive porous layer was 0.8 μm, a lithium metal secondary battery was prepared in the same manner as in Example 3.

### EVALUATION

The electrical conductivity, the surface resistivity, and the peel strength of the porous conductive coat layers of the separators prepared in each Example and Comparative Example were measured by the following methods. The results are illustrated in Table 1, along with the materials, coating methods, and thicknesses of the porous conductive coat layers of the separators. The presence or absence of short circuits and the rate of increase in lithium thickness for the lithium metal secondary batteries prepared in each Example and Comparative Example were measured by the following methods. The results are illustrated in Table 1.

### (Electrical Conductivity and Surface Resistivity of Porous Conductive Coat Layer)

The electrical conductivity and surface resistivity were measured using a high-precision multifunctional resistivity meter (Loresta GP, TCP-600, Nittoseiko Analytech Co., Ltd.).

### (Peel Strength)

A 2.5 cm wide adhesive tape was pressed onto a fixed plate, and a 5.0 cm long, 2.5 cm wide porous conductive coat layer was adhered to the tape. Then, one end of the porous conductive coat layer was folded back at 180 degrees, and the porous conductive coat layer was pulled up at a speed of 300 mm/min using an electric measurement stand (prepared by IMADA Co., Ltd.) to peel from the porous membrane. The force required to start and complete the peeling of the porous conductive coat layer was measured using a digital force gauge (manufactured by IMADA Co., Ltd.). The average value of the obtained force was divided by the width of the adhesive tape, and was taken as the peel strength.

### (Presence or Absence of Short Circuits in Lithium Metal Secondary Battery)

The freshly prepared lithium metal secondary battery was left to stand at a measurement temperature of 25° C. for 24 hours. After the standing period, the first charge-discharge cycle was performed for 3 cycles, followed by the second charge-discharge cycle for 50 cycles to check for the presence or absence of short circuits in the lithium metal secondary battery. When the charge capacity of the lithium metal secondary battery became 105% or more, relative to the discharge capacity before charging, it was considered that a short circuit had occurred, and the battery was classified as having a short circuit.

In the first charge-discharge cycle, charging was performed up to 4.300 V at a current value of 2.2 mA under constant current conditions, followed by constant voltage charging at a voltage value of 4.300 V for 60 minutes. Discharging was performed under constant current conditions down to 2.65 V at a current value of 4 mA. A resting period of 30 minutes was allowed between discharge and charge.

In the second charge-discharge cycle, charging was performed with a current value of 74 mA up to 3.823 V, with 52 mA up to 4.051 V, with 46 mA up to 4.173 V, and with 22 mA up to 4.300 V under constant current conditions, followed by constant voltage charging at 4.300 V for 90 minutes. Discharging was performed with a current value of 18 mA down to 2.65 V under constant current conditions. A resting period of 30 minutes was allowed between discharge and charge.

### (Rate of Increase in Lithium Thickness of Lithium Metal Secondary Battery)

The thickness T1 (μm) of the negative electrode during the initial charge and the thickness T2 (μm) of the negative electrode after 50 cycles of charging were measured, and the rate of increase in thickness T (μm/cycle) was calculated using the following formula:

$$T ( μ m / cycle ) = ( T 2 - T 1 ) / 50$$

The thickness T1 (μm) of the negative electrode during the initial charge was measured as follows:

The freshly prepared lithium metal secondary battery was left to stand at a measurement temperature of 25° C. for 24 hours. After the standing period, the first charge-discharge cycle was performed for 3 cycles. Then, constant current charging was performed at a current value of 14.7 mA up to 4.300 V, followed by constant voltage charging at 4.300 V for 60 minutes to charge the lithium metal secondary battery. After charging, the lithium metal secondary battery was left to stand for 30 minutes, then disassembled, and the thickness of the removed negative electrode was measured as T1.

The thickness T2 of the negative electrode during charging after 50 cycles was measured as follows:

The freshly prepared lithium metal secondary battery was left to stand at a measurement temperature of 25° C. for 24 hours. After the standing period, the first charge-discharge cycle was performed for 3 cycles, followed by the second charge-discharge cycle for 50 cycles. Then, constant current charging was performed at a current value of 14.7 mA up to 4.300 V, followed by constant voltage charging at 4.300 V for 60 minutes to charge the lithium metal secondary battery. After charging, the lithium metal secondary battery was left to stand for 30 minutes, then disassembled, and the thickness of the removed negative electrode was measured as T2.

TABLE 1

| | Porous conductive layer | | | | | | Lithium metal secondary battery | |
|---|---|---|---|---|---|---|---|---|
| | | | | Electrical | Surface | Peel | Presence or | Rate of increase |
| | | Coating | Thickness | conductivity | resistivity | strength | absence of | in lithium |
| | Material | method | (μm) | (S/cm) | (Ω/cm²) | (N/m) | short | thickness |
| Example 1 | Cu | RF sputtering | 0.08 | 3.8 × 10⁴ | 3.5 | 260 | Absent | 0.42 |
| | | method | | | | | | |
| Example 2 | Zn | RF sputtering | 0.06 | 3.6 × 10³ | 200 | 270 | Absent | 0.50 |
| | | method | | | | | | |
| Example 3 | CNT | Application | 2.10 | 1.0 × 10¹ | 83 | 0.5 | Absent | 0.56 |
| | | method | | | | | | |
| Example 4 | Sn | RF sputtering | 0.10 | 6.3 × 10² | 190 | 270 | Absent | 0.52 |
| | | method | | | | | | |
| Comparative | — | | | | | | Present | 1.00 |
| Example 1 | | | | | | | | |
| Comparative | Graphite | RF sputtering | 0.08 | 7.7 × 10⁻² | 1790000 | 250 | Absent | 1.04 |
| Example 2 | | method | | | | | | |
| Comparative | AB | Application | 11 | 5.4 | 1880 | 1 | Present | — |
| Example 3 | | method | | | | | | |
| Comparative | VGCF-H | Application | 9 | 1.5 | 558 | 1 | Present | — |
| Example 4 | | method | | | | | | |
| Comparative | CNT | Application | 0.80 | 1.0 × 10¹ | 280 | 0.3 | Absent | 1.00 |
| Example 5 | | method | | | | | | |

As illustrated in Table 1, the lithium metal secondary batteries of Examples 1 to 4, which include a separator with a porous conductive coat layer having the electrical conductivity within the range of the present invention, are less likely to experience short circuits even after repeated charge-discharge cycles, have a low rate of increase in lithium thickness, and form a compact and dense negative electrode active material layer upon charging. In contrast, the lithium metal secondary batteries of Comparative Examples 1 to 5, which include a separator without a porous conductive coat layer or have a porous conductive coat layer having the electrical conductivity lower than the range of the present invention, tend to develop short circuits after repeated charge-discharge cycles, have a high rate of increase in lithium thickness, and form a coarse and low-density negative electrode active material layer upon charging.

### (Negative Electrode Active Material Layer in Charged State After 50 Charge-Discharge Cycles)

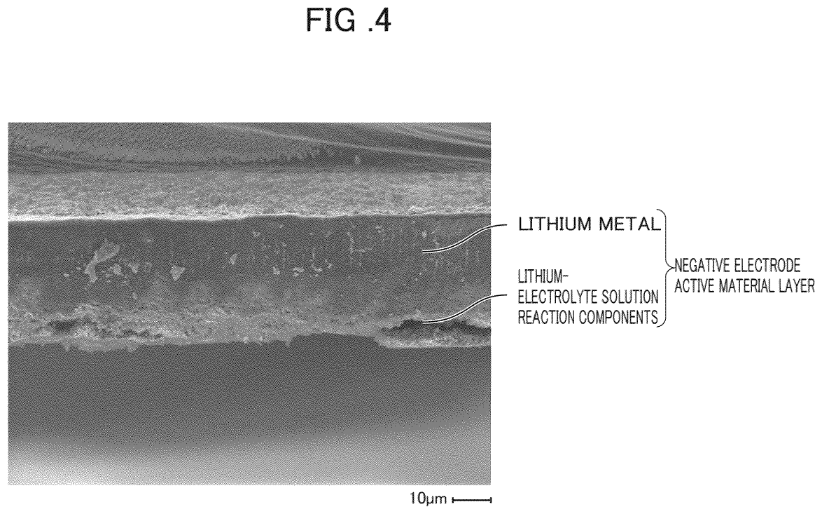

The negative electrode active material layers in a charged state after 50 cycles of charge-discharge of the lithium metal secondary batteries prepared in each Example and Comparative Example were observed. The charge-discharge cycles were performed similarly to the measurement of the rate of increase in lithium thickness, with the first charge-discharge cycle for 3 cycles, followed by the second charge-discharge cycle for 50 cycles. The lithium metal secondary batteries in a charged state after 50 charge-discharge cycles were disassembled, and the cross-sections of the obtained negative electrodes were observed using SEM (scanning electron microscope). SEM photographs of the cross-sections of the negative electrode active material layers in a charged state after 50 charge-discharge cycles for the lithium metal secondary batteries obtained in Example 3, Comparative Examples 1 and 5 are illustrated in FIGS. 4 to 6.

From the cross-sectional SEM photograph in FIG. 4, it can be seen that the negative electrode active material layer of the lithium metal secondary battery obtained in Example 3, after 50 cycles, is mainly formed from lithium metal, with lithium-electrolyte solution reaction components (SEI: solid electrolyte interphase) slightly generated on the side of the negative electrode current collector. Thus, from this cross-sectional SEM photograph, it can be understood that the negative electrode active material layer formed upon charging in the lithium metal secondary battery obtained in Example 3 is compact and dense. For the lithium metal secondary batteries obtained in Examples 1, 2, and 4, cross-sectional SEM photographs also confirmed that the negative electrode active material layer after 50 cycles is mainly formed from lithium metal.

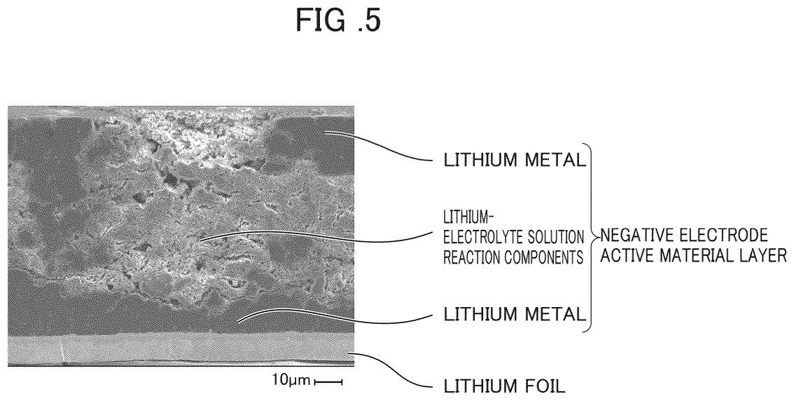

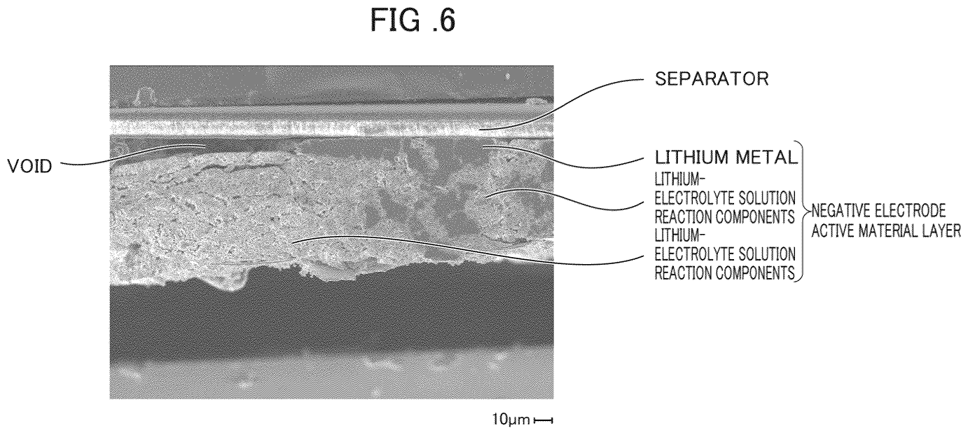

From the cross-sectional SEM photograph in FIG. 5, it can be observed that the lithium metal secondary battery obtained in Comparative Example 1 has a coarse lithium-electrolyte solution reaction component (SEI: solid electrolyte interphase) formed in the negative electrode active material layer after 50 cycles. Therefore, from this cross-sectional SEM photograph, it can be understood that the negative electrode active material layer formed upon charging in the lithium metal secondary battery obtained in Comparative Example 1 is coarse and has a low density. Furthermore, from the cross-sectional SEM photograph in FIG. 6, it is observed that the lithium metal secondary battery obtained in Comparative Example 5 has a coarse lithium-electrolyte solution reaction component (SEI: solid electrolyte interphase) formed in the negative electrode active material layer after 50 cycles, with voids formed between the SEI and the separator. Hence, from this cross-sectional SEM photograph, it can be understood that the negative electrode active material layer formed upon charging in the lithium metal secondary battery obtained in Comparative Example 5 is coarse and has a low density.

### EXPLANATION OF REFERENCE NUMERALS

10a, 10b: electrode stack
20: positive electrode
21: positive electrode current collector
22: positive electrode active material layer
25: positive electrode lead terminal
30, 30a, 30b: negative electrode
31: negative electrode current collector
32: lithium foil
33: negative electrode active material layer
35: negative electrode lead terminal
40: separator
41: porous membrane
42: porous conductive coat layer
50: exterior body

What is claimed is:

1. A lithium metal secondary battery, comprising:
an electrode stack formed by stacking a positive electrode and a negative electrode having a negative electrode current collector with a separator interposed therebetween; and
an electrolyte solution,
wherein lithium is deposited on the negative electrode current collector during charging and dissolved during discharging,
wherein the separator includes a porous membrane and a porous conductive coat layer stacked on at least part of a surface of the porous membrane on the side of the negative electrode,
wherein electrical conductivity of the porous conductive coat layer is within a range of 1.0×10¹ to 1.0×10⁵ S/cm, and
wherein surface resistivity of the porous conductive coat layer is 200 Ω/cm² or less.

2. The lithium metal secondary battery according to claim 1,
wherein the porous conductive coat layer has a region that contacts the lithium deposited on the negative electrode current collector.

3. The lithium metal secondary battery according to claim 1,
wherein electrical conductivity of the negative electrode current collector is higher than electrical conductivity of the porous conductive coat layer.

4. The lithium metal secondary battery according to claim 1,
wherein peel strength of the porous conductive coat layer against the porous membrane is 0.5 N/m or more.

5. The lithium metal secondary battery according to claim 1,
wherein thickness of the porous conductive coat layer is within a range of 0.01 to 5 μm.

6. A secondary battery module comprising a plurality of the lithium metal secondary batteries according to claim 1,
wherein the plurality of lithium metal secondary batteries are each restrained with a restraining force within a range of 0.1 to 2.0 MPa along a stacking direction of the electrode stack.

7. A separator for a lithium metal secondary battery, the separator comprising a porous membrane and a porous conductive coat layer stacked on one surface of the porous membrane,
wherein electrical conductivity of the porous conductive coat layer is within a range of 1.0×10¹ to 1.0×10⁵ S/cm, and surface resistivity of the porous conductive coat layer is 200 Ω/cm² or less.
